(19) United States
(12) Patent Application Publication
(10) Pub. No.: US 2008/0206014 A1
(43) Pub. Date: Aug. 28, 2008

(54) Self-drilling and slotting fastener with retainer

(76) Inventor: Robert J. Lemire, Kings Park, NY (US)

Correspondence Address: Robert J. Lemire, P.O. Box 299, Kings Park, NY, 11754, US

(21) Appl. No.: 11/709,358

(22) Filed: Feb. 22, 2007

(51) Int. Cl. F16B 21/00

(52) U.S. Cl. 411/344

(57) ABSTRACT

The self-drilling and slotting fastener with retainer has a thin retainer wire that is used to bring the flat nut portion that is inserted through a wall into position with the hole in the wall for a screw to mate with the threads in the nut. The nut has a rectangular body shape with a thin elongated section extending from away from one side. This elongated section has a drilling point and serrated teeth for making a slot. It looks almost like a car key. The drilling point makes a hole wide enough for the matting screw and is long enough to go completely through the wall. The serrated teeth on the elongated section are used to make horizontal slots on each side of the hole to accommodate the narrow width of the nut body. The resulting slotted hole is clean and provides a smooth and uniform surface on the inner surface of the wall for the nut to rest against. The drilling & sawing section is crimped at the juncture with the body and has a hole in it for being put on the retaining wire. After the hole and slot is made in the wall the elongated section is broken off and put on the retainer wire so it keeps the nut from falling inside the wall. The nut is put into position over the hole by pulling on the cord. The rectangular flat nut then rests against the inside surface of the wall and has a wide area for holding the object. This provides an improvement in holding capacity for this system.

### CROSS-REFERENCE TO RELATED APPLICATIONS

The application Ser. No. 10/967,690 was for a similar concept and has become abandoned. Another application has been submitted that overcomes the prior art listed by the examiner to that application. The new application number is Ser. No. 11/507,990. It has two different methods shown for self-drilling and slotting with an integral drill and saw. This current application is an improvement over one of the designs in that application.

### STATEMENT RE: FEDERALLY SPONSORED RESEARCH/DEVELOPMENT

(Not Applicable)

### BACKGROUND OF THE INVENTION

The present invention generally relates to a blind fastening system for holding objects onto a modern gypsum wall. It is composed of a flat fastening nut that has a rectangular section with a center threaded hole and an extended narrow section that has serrated teeth and comes to a point. This extended section is slightly wider than the diameter of the screw that fits into the threaded hole in the rectangular section. This extended section is long enough to go through the gypsum board used on the wall. It is crimped at the point where it meets the rectangular section so that it can be broken off. The pointed end is used to manually drill a hole for a screw. After the hole has been drilled the saw section is used to make slots on each side of the screw hole. The total width of these slots is a little longer than the short side of the rectangular section of the fastening nut.

There is a flexible retaining wire that has elongated ends at right angles to the wire. The elongated ends can be bent over for insertion through the retaining holes. The fastener has three retaining holes in addition to the threaded hole in the rectangular nut section. The retaining holes in the rectangular section are located so that they straddle the threaded hole. These two retaining holes are aligned along the center of the long side of the nut and are spaced so that the distance between them equals the width of the short side of the rectangular section. There is a third retaining hole in the center of the break away extended section that is put on the wire before inserting the nut through the wall. The flexible retaining wire is threaded in succession through a first retaining hole in the back of the rectangular section, then through the hole in the break away extended section and then back through the second retaining hole in the rectangular section. The ends of the retaining wire are both on the back face of the fastener nut and have the broken away piece on the front face.

The fastener nut can then be inserted through the slotted hole in the surface and held in alignment by the retainer wire and the broken off section. Pulling on the retainer wire rotates the nut 90 degrees and aligns the center threaded hole in the fastener nut with the screw hole in the wall. The broken off section, now on the retaining wire, prevents the nut and wire from being pulled through the hole by the weight of the nut if the wire happens to be released.

There are numerous fastening devices that all try to maximize the holding power that the fastener exerts onto the back of the surface it is placed onto. The holding power is directly proportional to the amount of surface area that the fastener has on the inside surface of the wall. The size of the opening in the surface needed for the insertion of the fastener is another factor in determining the holding power of a fastener. The smaller the hole is the less damage the surface received, and the stronger the surface is. It is of primary importance that a clean hole be made in the wall for the fastener to achieve maximum holding power. Many products attempt to achieve this capability; however, they quite often fall short.

U.S. Pat. No. 5,472,304 by Gold shows a flat wedge shaped fastener being driven through a wall and being used as a fastener. The problem with this device is that the back of the wall gets “blown-out”. That is, the inside portion of the wall gets damaged and does not provide a clean flat surface for the fastener to rest against. In addition to the back surface the material between the front and back face of the wall gets damaged. Another problem is the insertion of the screw through the hole made by the wedge. The width of the screw is usually greater than the width of the wedge and also causes the back of the wall to become “blown-out”. To avoid that, the thickness of the wedge would have to match the thickness of the screw, as shown on FIGS. 6 & 7. Having such a wide wedge only compounds the “blow-out” problem.

U.S. Pat. No. 1,521,024 by Hubener shows a fastener that makes use of the flexible cord used to align a fastener nut with a matting screw. This system requires that a hole be drilled through the wall by a standard tool. The width of the fastener nut is also limited by the size of the hole made in the wall.

U.S. Pat. No. 2,765,134 by Hill shows a fastener that is using a hollow screw. The limitations mentioned with Hubener also apply to this patent.

U.S. Pat. No. 3,267,793 by Devine et al; U.S. Pat. No. 3,473,431 by King; U.S. Pat. No. 4,183,386 by Brown; U.S. Pat. No. 4,971,502; U.S. Pat. No. 5,110,243 by Oh; U.S. Pat. No. 5,197,839 by Willey; and U.S. Pat. No. 5,236,293 by McSherry et al shows fastening devices that all require a predrilled hole.

The fastening system described in this application maximizes the holding power by having almost the entire flat surface of the fastener against the inside surface of the wall. It makes use of the retaining features shown in Hubener (U.S. Pat. No. 1,521,024) and Hill (U.S. Pat. No. 2,765,134); however it also incorporates a self-drilling and slotting feature that none of the above patents demonstrate.

In addition to having a maximum of holding power and minimum of wall damage, this fastening system is simple to use and inexpensive to manufacture.

### BRIEF SUMMARY OF THE INVENTION

In accordance with the preferred embodiment of the present invention there is provided a blind fastening system composed of a self-drilling and slotting threaded nut, a thin and flexible retainer wire, and a screw.

The pointed end of the elongated side of the fastener nut is used to manually drill a hole in the gypsum board. After the center hole has been made the serrated portion of the elongated side is used to make opposing slots that are wide enough to accommodate the narrow side of the rectangular fastener nut. This creates a clean slotted hole without significant damage to the interior or back surface of the wall. This is accomplished without the need for a drill or a saw blade since each fastener nut has a built-in drill and saw.

After the slotted hole has been made in the wall the extended drill and saw section is broken off at the crimp, leaving only the rectangular fastener nut. The retaining wire is then passed in succession through the back face of one of the retaining holes, the hole in the broken off section, then back into the second retaining hole. The fastener nut is then turned so the shorter side is inserted through the slotted hole so that the retainer wire and broken off section are holding the fastener nut from falling. The retainer wire is then pulled to align the fastener nut with the screw hole in the wall. This aligns the threaded hole with the screw hole while simultaneously completely covering the slotted hole made in the wall. A screw is then placed through the object being hung and is inserted into the threaded hole in the fastener nut and turned to engage the threads. The fastener nut on the inside of the wall is flush against it and completely covers the slotted hole made in the wall.

The amount of holding capability of this fastener nut is a function of the surface area of the nut and the strength of the surface it is being used on. For gypsum walls the length and width of the fastener nut will be a deciding factor along with the thickness of the wall. This fastener can be used with all gypsum walls, and the holding power will differ based on the wall thickness.

### BRIEF DESCRIPTION OF THE DRAWINGS

These as well as other features of the present invention, will become more apparent upon reference to the drawings wherein:

FIG. 1 is a cross sectional view of a drilled hole in a gypsum wall

FIG. 2 is a cross sectional view of a hole punched through a gypsum wall

FIG. 3 is a plan view of the thin rectangular metal fastener nut with a removable drilling tip and saw section with retaining wire

FIG. 4 is a plan view of the slotted hole made with the elongated section of the fastener nut

FIG. 5 is a plan view from the inside of a wall showing the self-drilling and slotting fastener nut against the inside face of the wall, the retaining wire, and the broken off elongated drill and saw section on the retaining wire on the outside of the wall

FIG. 6 is a sectional view of FIG. 5 and shows the screw through an object to be fastened to the wall

### DETAILED DESCRIPTION OF THE INVENTION

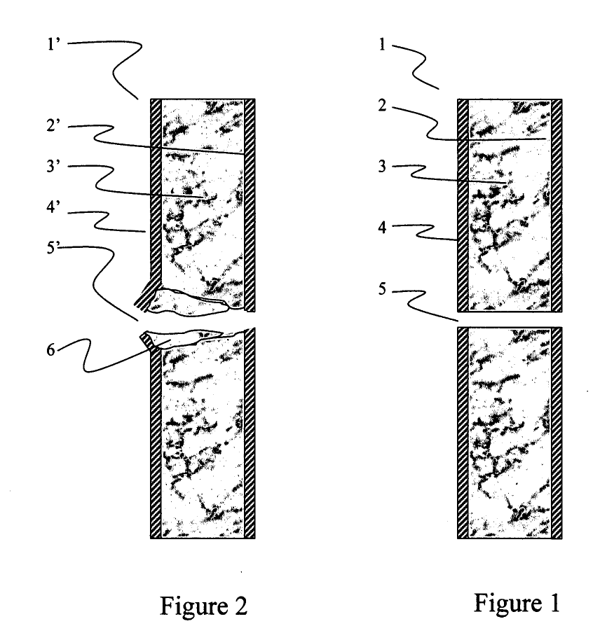

With reference to the drawings in which like reference characters designate like or corresponding parts throughout the various views and with particular reference to FIG. 1, which is a cross sectional view of a drilled hole 5 in a gypsum wall 1 where the outside and inside faces 2 and 4 are covering the gypsum material 3.

FIG. 2 is a cross sectional view of a punched hole 5′ in a gypsum wall 1′ where the outside and inside faces 2′ and 4′ are covering the gypsum material 3′. The punching process may make a clean hole on the outside face 2′, however, it damages the inner gypsum core 6 and tears the inner face 4′. This action weakens the entire area around this hole.

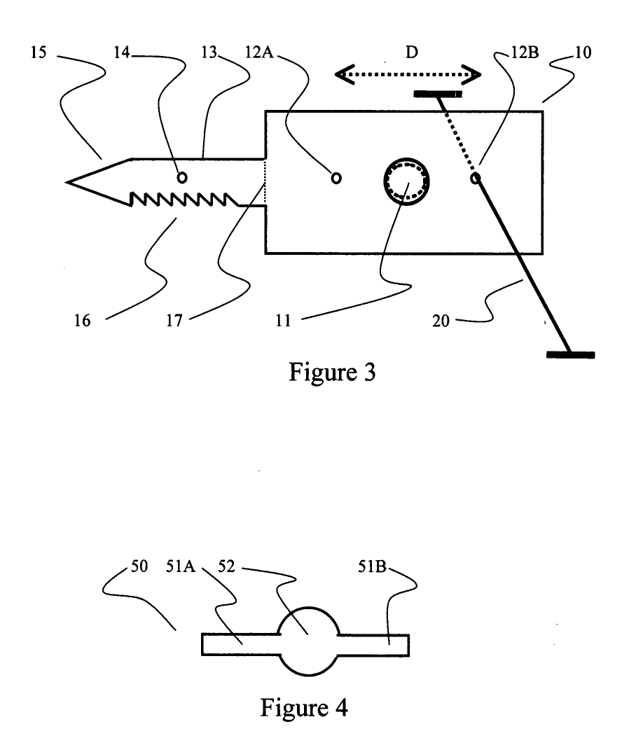

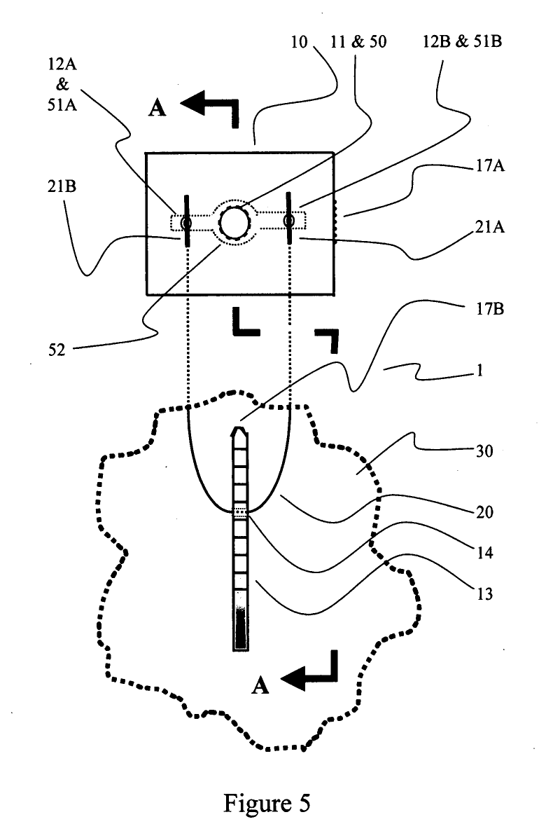

FIG. 3 is a plan view of the rectangular self-drilling and slotting fastener nut 10 composed of a thin metal stamping. Fastener nut 10 also has a threaded center hole 11 and retaining holes 12A and 12B straddling the center hole 10 along the centerline of the long side of the nut 10. Holes 12A and 12B are separated by the distance D that is equal to the width of the short side of the nut 10. There is an elongated section 13 extending from one side of the nut 10. This elongated section 13 has a width that is slightly larger than the diameter of the screw that mates with threaded hole 11. Elongated section 13 has a drilling point 15 at its end and a serrated side 16. This elongated section 13 is crimped at its base 17 with the fastener nut 10 and has a retaining hole 14 in it. The elongated side is long enough to penetrate the thickness of the wall 1 so that its serrated side 16 extends beyond the inner face 4 of the wall and acts like a saw for making clean slots in the wall. Retaining wire 20 is shown through retaining hole 12B. After the hole has been made in the wall 1 the drilling section 13 is removed and wire 20 is placed through retaining hole 14 in it. The wire 20 is then placed through retaining hole 12A to form the final assemblage shown on FIGS. 5 & 6 and it is now ready to be inserted through the wall.

FIG. 4 is a plan view of the slotted hole 50 produced by manually using the fastener nut 10 as a drill and a saw to form it. Turning the pointed end 16 of fastener nut 10 into a gypsum wall 1 drills the clean circular hole 52 through the wall 1. After hole 52 is through the wall the serrated side 16 of the fastener nut 10 is used to make slots 51A & 51B on each side of the center hole 52. These slots are made so they are slightly longer than the short side of fastener nut 10.

FIG. 5 is a plan view from the inside of wall 1 showing the slotted hole 50 being covered by rectangular self-drilling and slotting fastener nut 10 with the elongated section 13 removed at location 17A and being held against the inside face of the wall 1. The broken off elongated section 13 is removed by bending it at the crimp 17 and forming 17B on the fastener nut 10 and 17A on the elongated section 13. The fastener nut 10 is then threaded with the retaining wire 20 so that the wire ends are on the back side of nut 10 through retaining holes 12A and 12B, and broken off section 13 is on the wire 20 in the front of the nut 10. The fastener nut 10 is then aligned with the narrow side into slotted hole 50. This has the wire 20 and its ends lined up with the center hole 52 so they do not damage the wall during the insertion. The fastener nut 10 is manually pushed through the slotted hole 50 made in the wall 1. The retaining wire 20 and elongated section 13 keep the fastener nut 10 from falling. Pulling on the retaining wire 20 positions the fastener nut 10 so that the threaded hole 11 is in line with hole 52 and the nut has been rotated 90 degrees to completely cover the hole in the wall. Removed wall section 30 shows how the retaining wire 20 is through retaining hole 14 and holds the broken off elongated section 13 on the front face of the wall.

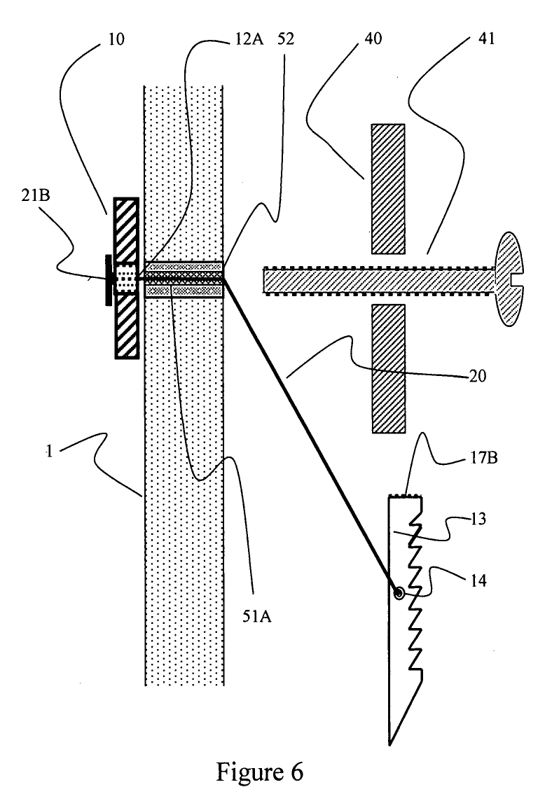

FIG. 6 is section A-A from FIG. 5. It shows the rectangular fastener nut 10 with retaining wire 21B through hole 12A against wall 1. The retaining wire 20 then goes through wall slot 51A to the front face off wall 1 and through retaining hole 14 in broken off section 13 that has broken crimp at 17B. Screw 41 is positioned through object 40 and ready to be inserted into fastener nut 10.

Additional modifications and improvements of the present invention may also be apparent to those of ordinary skill in the art. Thus, the particular combination of parts described and illustrated herein is intended to represent only a certain embodiment of the present invention, and is not intended to serve as limitations of alternative devices within the spirit and scope of the invention. Any changes in the size or orientation of various components is one such example.

What is claimed is:

1. A blind fastening system for gypsum walls that is composed of a standard screw, a thin metal fastening nut that combines the ability to produce its own slotted hole through the wall with a removable drill and saw section, a thin flexible wire for holding the removable drill and saw section and the nut by going through retaining holes in said nut, such that the assemblage has the means to keep the nut from falling and have its threaded hole aligned with a fastening screw;

2. The combination as defined in claim 1 wherein said fastening system has the following:
a. a thin rectangular metal fastening nut having a threaded hole and an elongated side that is wider than said threaded hole, wherein said elongated side has a center hole, a serrated side and a drilling point, and is further crimped at its base for removal from the nut; whereby said elongated side is of sufficient length to penetrate a wall and make a circular hole by manually turning the fastening nut with the drilling point against the wall, and using the serrated side to cut slots on each side of said hole for the passage of the narrow width of the fastening nut; and is further configured to have small retaining holes on each side of the threaded hole for the passage of a retaining wire, whereby the distance between the retaining holes is the length of the short side of the nut;
b. a retaining wire having elongated ends, with its ends through the back of the retaining holes in the fastener nut, and having the retaining hole in the broken off drill section on the wire in the front face of the nut, so that the fastener nut is kept from falling when inserted through the slotted hole in the wall by the broken off drill section on the looped section of the retaining wire extending through the wall;
c. a standard screw through a hole in the object being fastened that mates with the threads of the threaded hole in the fastener nut when the retaining wire is pulled to align the threaded hole with the center of the slotted hole in the wall;
whereas, the screw is able to mesh with the threaded hole, and the nut is kept from rotating by the pulling of the retaining wire and the nut has a 90 degree rotation so that its long side is completely covering the slotted hole made in the wall.
